(19) United States
(12) Patent Application Publication
(10) Pub. No.: US 2018/0119875 A1
(43) Pub. Date: May 3, 2018

(54) APPARATUS ADAPTED FOR HANGING AN ARTICLE ON A FENCE RAIL

(71) Applicant: Robert B. Fowler, Bennettsville, SC (US)

(72) Inventor: Robert B. Fowler, Bennettsville, SC (US)

(21) Appl. No.: 15/338,500

(22) Filed: Oct. 31, 2016

(51) Int. Cl. F16M 13/02; E04H 17/20

(52) U.S. Cl. CPC F16M 13/022; F21V 21/08; E04H 17/20

(57) ABSTRACT

An apparatus adapted for hanging an article on a fence rail is provided and comprised of a rod having a proximate end and a distal end. The rod has three bends bounded by four portions. The first bend forms a substantially 90 degree angle between the first portion and the second portion. The second bend is a substantially 90 degree angle between the second portion and the third portion. The first portion, the second portion, and third portion being substantially in a first plane. The third bend forms a substantially 90 degree angle between the third portion and the fourth portion. The fourth portion initially extends parallel to the second portion and subsequently forming a radius. The fourth portion is in a second plane substantially perpendicular to the first plane.

### FIELD OF THE INVENTION

The invention relates to an apparatus for holding articles and more particularly to an apparatus which hangs from a fence and hold articles.

### BACKGROUND OF THE INVENTION

Safe, orderly, and convenient storage of outdoor equipment, for example ladders and garden hoses and the like, is sometimes difficult to find. Fences can provide real estate to hang such items. Often also, fences provide a suitable structure on which to display or hang potted plants. Hangers for storing articles are particularly designed for chain-link style fences because of the popularity of chain-link fences and because the chain-link fence provide numerous options for hangers to be supported.

U.S. Pat. No. 8,251,331 issued to the current applicant, provides for a fence hanger apparatus generally comprised of two vertical hanging support brackets. The two vertical hanging support brackets each have an upper portion terminating in a U-shaped hook for hanging the apparatus over the top rail of a fence, and a lower portion. A vertical member has an upper end and a lower end and is positioned approximately midway between the two vertical hanging support brackets and is substantially parallel to the upper portions of the two vertical hanging brackets. The upper end of the vertical member extends substantially to the same height as the U-shaped hooks. The vertical member has a front face, a rear face and two side faces. The front face of the vertical member is provided with means for attaching hanging members. A U-shaped latch is pivotally mounted to the lower end of the vertical member for attaching the apparatus to a vertical post of a fence. The lower portions of the two hanging support brackets are secured to the lower end of the vertical member with securing means. While this arrangement works well and is robust, greater simplicity, especially in manufacture may be desired.

U.S. Pat. No. 6,209,837 provides a single piece of rod for a vertical baluster bracket. The rod of the '837 patent has a cantilever arm and bent portions adapted to surround the baluster. Because of the arrangement of the bent portions of the rod, any load on the cantilever causes the bracket to bind to the baluster. The '837 patent has simplicity of design and manufacture, but is limited to balusters.

What is needed and is apparently lacking in the art is an apparatus adapted for hanging an article on a fence rail that has simplicity of design and manufacture.

### SUMMARY

In one aspect, the present invention embraces an apparatus adapted for hanging an article on a fence rail which is of simple design and manufacture.

In an exemplary embodiment of the present invention, the apparatus is comprised of a rod having a proximate end and a distal end. The rod has three bends bounded by four portions. The first portion has a vertical orientation. The first bend forms a substantially 90 degree angle between the first portion and the second portion. The second portion has a horizontal orientation. The second bend is at least about half the length between the proximate end and the distal end of the rod. The second bend is a substantially 90 degree angle between the second portion and the third portion. The third portion has a vertical orientation. The first portion, the second portion, and third portion are substantially in a first plane. The third bend forms a substantially 90 degree angle between the third portion and the fourth portion. The fourth portion initially extends parallel to the second portion and subsequently forms a radius. The fourth portion is in a second plane substantially perpendicular to the first plane.

In another exemplary embodiment of the apparatus, the radius is sized to engage a vertical fence post.

In another exemplary embodiment of the apparatus, the first portion is less than about 6 inches in length.

In another exemplary embodiment of the apparatus, the rod is greater than about one-eighth inch in diameter.

In another exemplary embodiment of the apparatus, the rod is greater than about one-quarter inch in diameter.

In another exemplary embodiment of the apparatus, the rod is less than about one-half inch in diameter.

In another exemplary embodiment of the apparatus, the rod is made of a material selected from steel, aluminum, and plastic.

In yet another exemplary embodiment of the apparatus, the second portion is adapted to hold an article. The second portion extends over the top of a fence rail from the second bend. The third portion is adapted to extend parallel to, adjacent to, and behind a fence post. The fourth portion is adapted to extend around a front portion of the fence post, such that the article held on the second portion is biased by the fourth portion extending around the front portion of the fence post.

In another exemplary embodiment of the invention, the second portion is greater than about 4 inches and less than about 18 inches.

In another exemplary embodiment of the invention, the second portion is greater than about 6 inches and less than about 12 inches.

In another aspect, the invention embraces an apparatus adapted for hanging an article over a fence rail with a cantilever portion.

In an exemplary embodiment, the apparatus includes a rod having a proximate end and a distal end. The proximate end is comprised of a cantilever portion. The distal end is an anchoring portion. The cantilever portion has a horizontal orientation. The anchoring portion has a vertical portion and biasing portion. The cantilever portion and the anchoring portion are separated by a substantially 90 degree bend. The cantilever portion is adapted to hold an article. The cantilever portion extends over the fence rail from the substantially 90 degree bend. The vertical portion of the anchoring portion is adapted to extend parallel to, adjacent to, and behind a fence post. The biasing portion is adapted to extend around a front side of the fence post.

In another exemplary embodiment, the cantilever portion has a generally horizontal portion and a generally vertical portion. The horizontal portion and the vertical portion are at a substantially 90 degree orientation from each other. The vertical portion beginning at the proximate end.

In another exemplary embodiment, the horizontal portion of the cantilever portion has at least one trough.

In another exemplary embodiment, the apparatus further includes a trough in between the horizontal portion and the vertical portion of the cantilever portion.

In another exemplary embodiment, the rod is greater than about one-quarter inch and less than about two-thirds inch in diameter.

In another exemplary embodiment, the rod is made of a material selected from steel, aluminum, other metallic alloys and plastic.

In another exemplary embodiment, the biasing portion is adapted to extend around a front side of a round fence post.

In another exemplary embodiment, the biasing portion is adapted to extend around a front side of a square fence post.

In another exemplary embodiment, the substantially 90 degree bend separating the cantilever portion and the anchoring portion is adapted to the fence rail.

The foregoing illustrative summary, as well as explanations of other exemplary aspects and advantages of the invention are further explained within the following detailed description and the accompanying drawings.

### BRIEF DESCRIPTION OF THE DRAWINGS

FIG. 1 illustrates an exemplary embodiment of the apparatus of the present invention.

FIG. 2 illustrates an exemplary embodiment of the apparatus of the present invention mounted to a fence with an article hanging from the apparatus.

### DETAILED DESCRIPTION

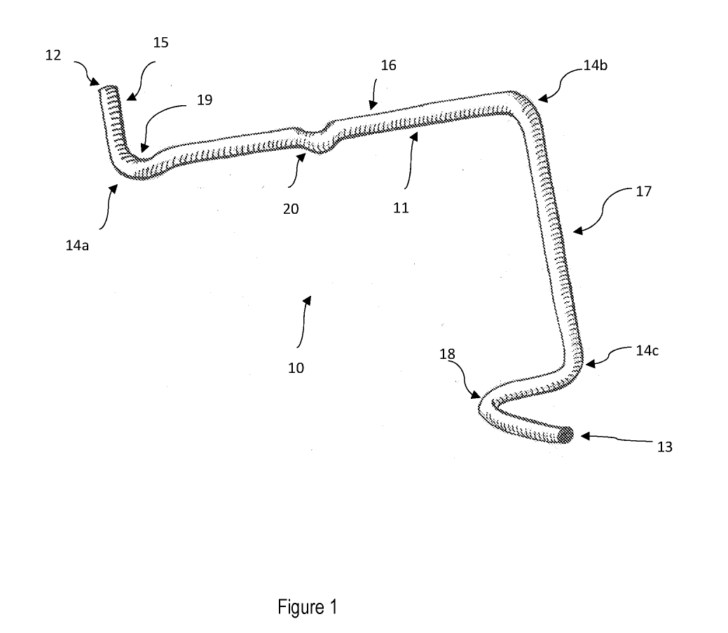

The present invention embraces an apparatus for hanging an article on a fence rail. An exemplary embodiment is generally illustrated in FIG. 1.

Referring now to FIG. 1, in an exemplary embodiment, the apparatus (10) is comprised of a rod (11) having a proximate end (12) and a distal end (13). The rod (11) has three bends designated as (14a, 14b, and 14c) bounding four portions. The first portion (15) has a vertical orientation with respect to the ground when mounted on a fence rail (not shown). The first bend (14a) forms a substantially 90 degree angle between the first portion (15) and the second portion (16).

The second portion (16) has a horizontal orientation with respect to the ground when mounted on a fence rail (not shown). The second portion (16), as can be seen presently, could also be referred to as a cantilever portion. The second bend (14b) is at least about half the length of the rod (11) between the proximate end (12) and the distal end (13). Preferably, the second bend (14b) is more than half the length of the rod (11) between the proximate end (12) and the distal end (13). The second bend (14b) forms a substantially 90 degree angle between the second portion (16) and the third portion (17). It is to be understood that the first and second bends (14a and 14b) may be rounded or curved. Further, the second bend (14b) may be shaped to be adapted to fit over the fence rail (not shown) where it is mounted. The third portion (17) has a vertical orientation and in fact would generally be parallel and adjacent to a vertical fence post (not shown).

The first portion (15), the second portion (16), and the third portion (17) are substantially in a first plane, as can be determined from the FIG. 1. The first plane would be generally perpendicular to the fence rail over which the apparatus (10) would sit.

The third bend (14c) forms a substantially 90 degree angle between the third portion (17) and the fourth portion (18). As can be seen from the FIG. 1, the fourth portion (18) initially extends parallel to the second portion (16), but subsequently forms a radius which is designed to secure or engage around the front of a vertical fence post (not shown). The fourth portion (18) engages the vertical fence post (not shown) and can be considered also a biasing portion, as an article hanging from the second or cantilever portion (16) is biased against the fence post by the fourth or biasing portion (18).

As shown, the fourth portion (18) radius is round, but the radius can accommodate any shaped post and would be curved accordingly. In fact in another exemplary embodiment, if the fence post is square, the fourth portion (18) would consist of a generally squared-off radius forming three-quarters of a rectangle, mimicking the dimensions of the fence post. The fourth portion (18), or the third portion (17) and fourth portion (18) together can be considered an anchoring portion of the apparatus (10). As can be seen from the FIG. 1, the fourth portion (18) is substantially in a second plane which is perpendicular to the first plane.

In general, the rod (11) can be made of any material that is pliable enough to machine bend into the desired shape of the apparatus (10), yet strong enough to hold the planned articles to be hung from the second portion (16) or cantilever portion of the apparatus (10). Preferably, the rod (11) is made from steel, aluminum, or plastic. However any material which can be formed and meet the strength criteria is acceptable.

Depending on the material for the rod (11) and the weight of the articles to be hung on the apparatus (10), the diameter of the rod (10) can be determined. Likewise, the length of the second portion (16) or the cantilever portion can be determined. However, in general, for most situations, the rod (11) is anticipated to be from about ⅛ inches in diameter to about ½ inch in diameter.

Likewise, the length of various portions of the rod (11) will be determined by the planned use, that is, weight of articles hung from the apparatus (10), and the material used for the rod (11). In general, however, the second portion (16) may be from about 4 inches in length to about 18 inches in length, although other lengths are possible.

At the first bend (14a), a trough (19) may be provided to help secure articles hung from the apparatus (10) at the first bend (14a). Likewise and/or in addition, a trough (20) may be provided at any section of the second portion (16) to assist in securing articles hung at the trough (20).

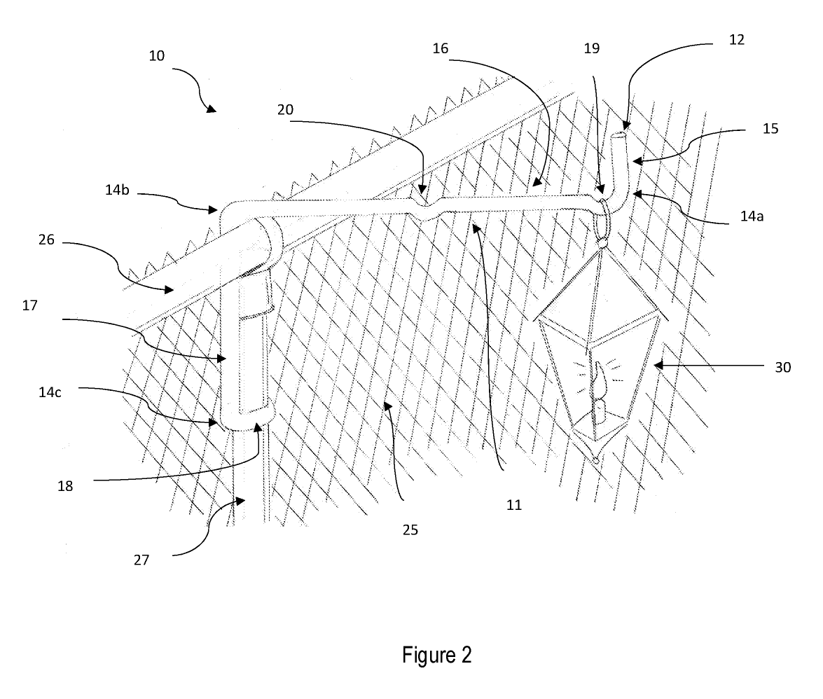

Referring now to FIG. 2, which illustrates an exemplary embodiment, the apparatus (10) of FIG. 1 mounted on a fence (25), is comprised of a rod (11) having a proximate end (12) and a distal end (13). The rod (11) has three bends designated as (14a, 14b, and 14c) bounding four portions. The first portion (15) has a generally vertical orientation with respect to the ground. The first bend (14a) forms a substantially 90 degree angle between the first portion (15) and the second portion (16).

The second portion (16) has a horizontal orientation. The second portion (16), as can be seen presently, could also be referred to as a cantilever portion. The second bend (14b) is at least about half the length of the rod (11) between the proximate end (12) and the distal end (not visible in this view, but labeled as (13) in FIG. 1). Preferably, the second bend (14b) is more than half the length of the rod (11) between the proximate end (12) and the distal end. The second bend (14b) forms a substantially 90 degree angle between the second portion (16) and the third portion (17). It is to be understood that the first and second bends (14a and 14b) may be rounded or curved as shown in the Figure. Further, the second bend (14b) may be shaped to be adapted to fit over the fence rail (26) where it is mounted. The third portion (17) has a vertical orientation and in fact would generally be parallel and adjacent to a vertical fence post (27).

The first portion (15), the second portion (16), and the third portion (17) are substantially in a first plane, being a vertical plane perpendicular to the fence rail (26) as can be seen from the present Figure.

The third bend (14c) forms a substantially 90 angle between the third portion (17) and the fourth portion (18). As can be seen from the present Figure, the fourth portion (18) initially extends parallel to the second portion (16), but subsequently forms a radius engaging and securing around the front of a vertical fence post (27). The fourth portion (18) engages the vertical fence post (27) and can be considered also a biasing portion, as the weight of the hanging article (30), shown as a lantern, hanging from the second or cantilever portion (16) is biased against the fence post by the fourth or biasing portion (18). The hanging article (30) is shown hanging from a trough (19) in the second portion (16). Alternately, the hanging article (30) or another article (not shown) may hang from the second trough (20) near the center of the second portion (16).

As shown, the fourth portion (18) radius is round, but the radius can accommodate any shaped post and would be curved accordingly. In fact in another exemplary embodiment, if the fence post is square (not shown, the fourth portion (18) would consist of a generally squared-off radius forming three-quarters of a rectangle, mimicking the dimensions of the fence post. The fourth portion (18), or the third portion (17) and fourth portion (18) together can be considered an anchoring portion of the apparatus (10). As can be seen from the present Figure, the fourth portion (18) is substantially in a second plane which is perpendicular to the first plane.

In the specification and/or figures, typical exemplary embodiments of the invention have been shown and disclosed. The present invention is not limited to such exemplary embodiments. The use of the term “and/or” includes any and all combinations of one or more of the described components. The figures are schematic representations and so are not necessarily drawn to scale. Unless otherwise noted, specific terms have been used in a generic and descriptive sense and not for purposes of limitation.

1. An apparatus adapted for hanging an article on a fence rail comprising:
a rod having a proximate end and a distal end;
the rod having three bends bounded by four portions;
the first portion having a vertical orientation;
the first bend forming a substantially 90 degree angle between the first portion and the second portion;
the second portion having a horizontal orientation;
the second bend being at least about half the length between the proximate end and the distal end of the rod, the second bend being a substantially 90 degree angle between the second portion and the third portion;
the third portion having a vertical orientation;
the first portion, the second portion, and third portion being substantially in a first plane;
the third bend forming a substantially 90 degree angle between the third portion and the fourth portion; and
the fourth portion initially extending parallel to the second portion and subsequently forming a radius, the fourth portion being in a second plane substantially perpendicular to the first plane.

2. The apparatus of claim 1, wherein the radius is sized to engage a vertical fence post.

3. The apparatus of claim 1, wherein the first portion is less than about 6 inches in length.

4. The apparatus of claim 1, wherein the rod is greater than about one-eighth inch in diameter.

5. The apparatus of claim 1, wherein the rod is greater than about one-quarter inch in diameter.

6. The apparatus of claim 1, wherein the rod is less than about one-half inch in diameter.

7. The apparatus of claim 1, wherein the rod is made of a material selected from steel, aluminum, metallic alloys, and plastic.

8. The apparatus of claim 1, wherein the second portion is adapted to hold an article; the second portion extending over the top of a fence rail from the second bend; the third portion being adapted to extend parallel to, adjacent to, and behind a fence post; and the fourth portion being adapted to extend around a front portion of the fence post, such that the article held on the second portion is biased by the fourth portion extending around the front portion of the fence post.

9. The apparatus of claim 1, wherein the second portion is greater than about 4 inches and less than about 18 inches.

10. The apparatus of claim 1, wherein the second portion is greater than about 6 inches and less than about 12 inches.

11-19. (canceled)

20. The apparatus of claim 1, wherein the second portion includes at least one trough disposed between the first bend and the second bend.
